(19) United States
(12) Patent Application Publication
(10) Pub. No.: US 2018/0178399 A1
(43) Pub. Date: Jun. 28, 2018

(54) Hair styling Scissors with Disposable Razor Blades

(71) Applicant: Debra Jean Anderson, Duncansville, PA (US)

(72) Inventor: Debra Jean Anderson, Duncansville, PA (US)

(21) Appl. No.: 15/390,518

(22) Filed: Dec. 25, 2016

(51) Int. Cl. B26B 13/24; B26B 29/04; B26B 21/12

(52) U.S. Cl. CPC B26B 13/24; B26B 21/12; B26B 29/04

(57) ABSTRACT

Described herein is a pair of scissors with razor blade implements to cut hair in a razor cut fashion.

### FIELD OF THE INVENTION

The invention relates generally to a pair of scissors with removable razor blade implements to cut hair in a razor cut fashion.

BACKGROUND

Currently there are a number of solutions for creating stylish haircuts. One of these solutions attempts to use a traditional pair of hairdressing scissors, but this solution fails to meet the needs of the market because the scissors are limited in the ability of cutting styles and don't give the feathering affect that a razor can. Another solution attempts to use a straight edge razor, but this solutions is similarly unable to meet the needs of the market because the razor is harder to use than scissors, can cut the user, and needs to be sharpened on a regular basis.

### SUMMARY OF THE INVENTION

It would be advantageous to have an apparatus that is easy to use like a scissors but cuts like a straight edge razor. Furthermore, it would also be advantageous to have an apparatus that did not require constant sharpening like a straight razor but instead used easily replaced disposable razor blades. Still further, it would be advantageous to have an apparatus that allows stylists to apply different razor cutting techniques just as easily as cutting hair with a scissors. Therefore, there currently exists a need in the market for an apparatus that is a pair of scissors to cut hair with a pair disposable razor blades on the interior edges. The blades are slid into the interior sides of the scissors and may include optional blade guards to avoid cutting oneself.

The invention advantageously fills the aforementioned deficiencies by providing a pair of scissors with razor blade implements to cut hair in a razor cut fashion, which provides ease of use and the ability to use a disposable blade.

The invention is cutting implement having a scissors body with disposable razor blades on the interior of the scissor blades to do razor cut styles on hair.

The apparatus has a compact size and comfort grip.

The apparatus fulfills the need for an implement to razor cut hair but makes the device easy to use, as the blades do not need to be sharpened, merely replaced with disposable razors.

Among other things, it is an advantage of the invention to provide a pair of scissors with razor blade implements to cut hair in a razor cut fashion that does not suffer from any of the problems or deficiencies associated with prior solutions.

It is still further an advantage of the invention is to be available in several colors.

Still further, the apparatus has optional blade guards to prevent the user from cutting themselves.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the back of the disposable blade.

FIG. 2 shows the bottom of the disposable blade.

FIG. 3 shows the front of the disposable blade.

FIG. 4 shows the left side of the disposable blade.

FIG. 5 shows the right side of the disposable blade.

FIG. 6 shows the top of the disposable blade.

FIG. 7 shows the back of the device.

FIG. 8 shows the bottom of the device.

FIG. 9 shows the front of the device.

FIG. 10 shows the left side of the device.

FIG. 11 shows the right side of the device.

FIG. 12 shows a three quarter view of the device.

FIG. 13 shows a three quarter view of the device.

FIG. 14 shows the top view of the device.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The invention is directed to be a pair of scissors with razor blade implements to cut hair in a razor cut fashion.

The invention is a scissors having disposable razor blades on the interior cutting or shearing surface of the scissor with the purpose of cutting hair. Additionally, the scissors includes guards for the removable and disposable blades of the scissors. In the preferred embodiment of the present invention, the scissors device is designed for comfort and includes multiple colored options.

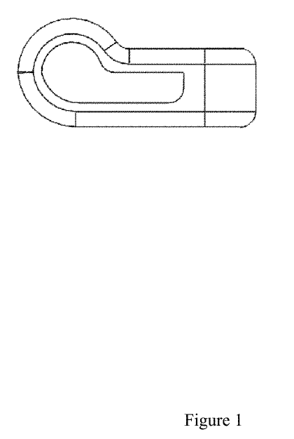

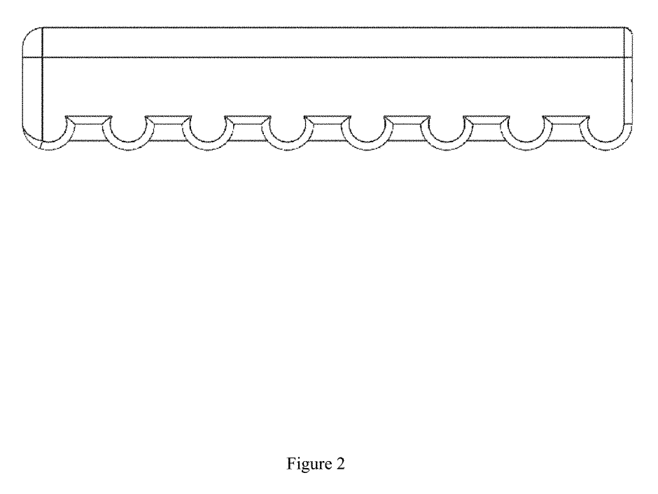

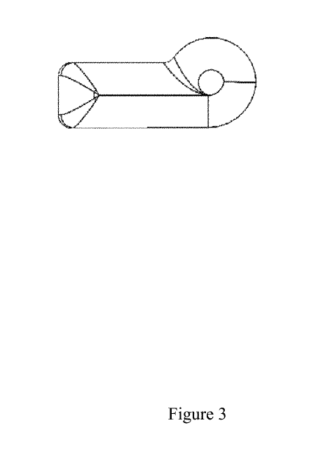

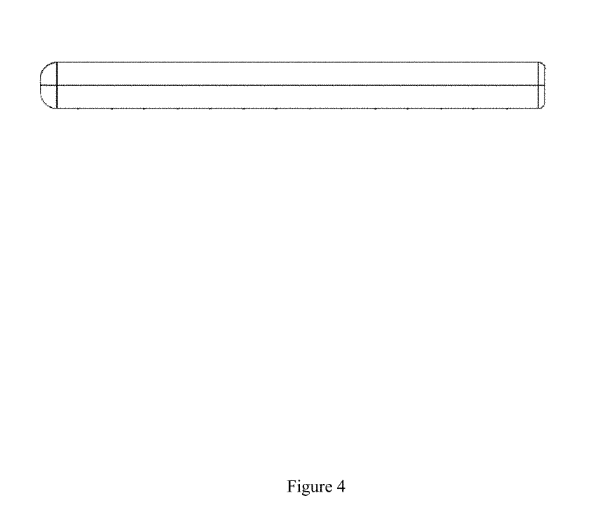

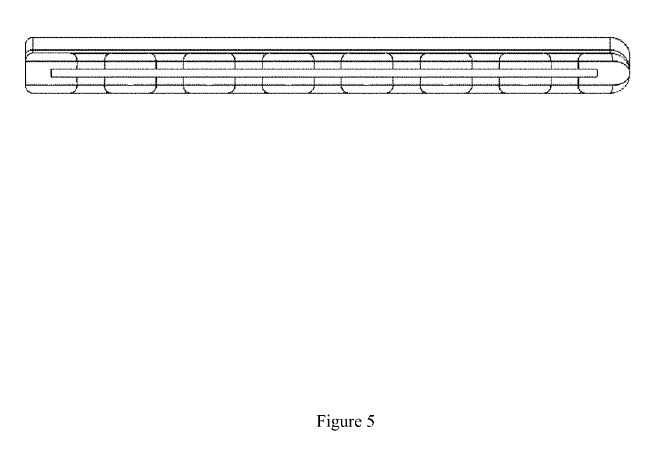

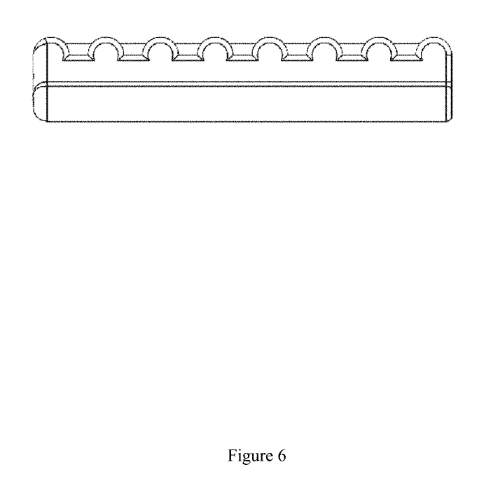

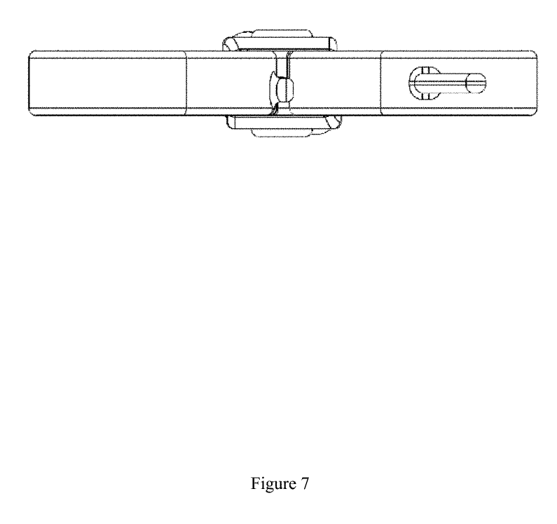

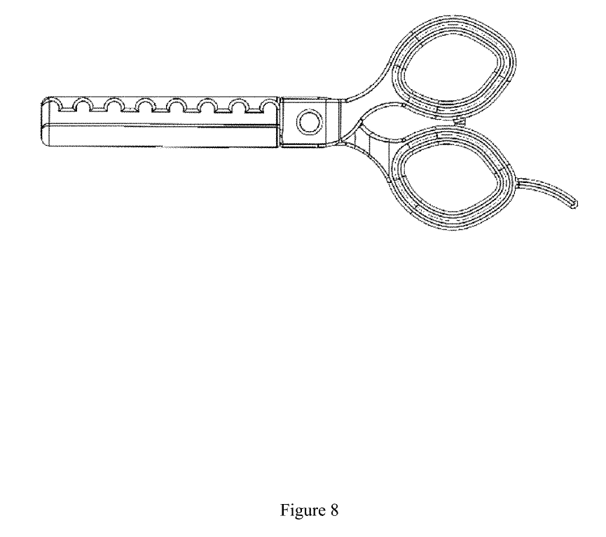

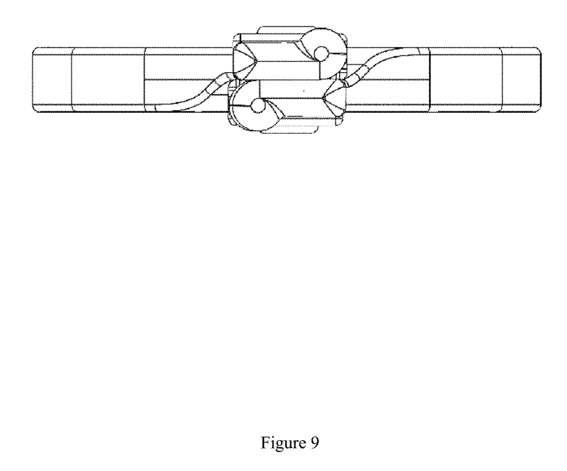

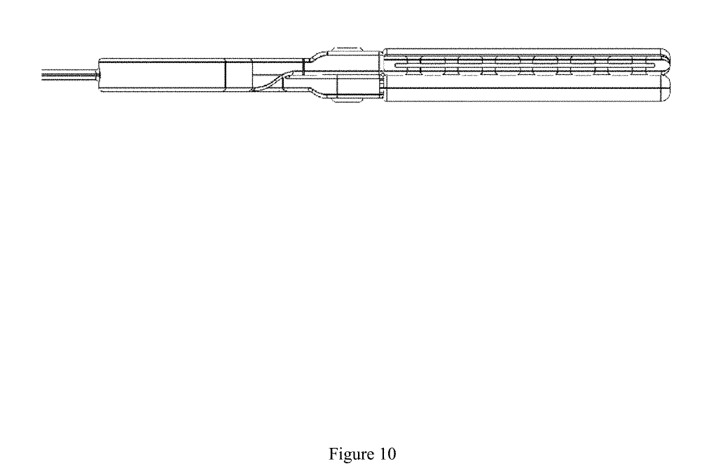

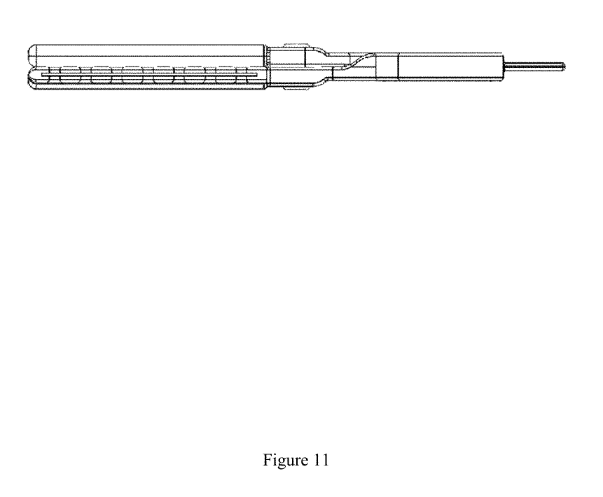

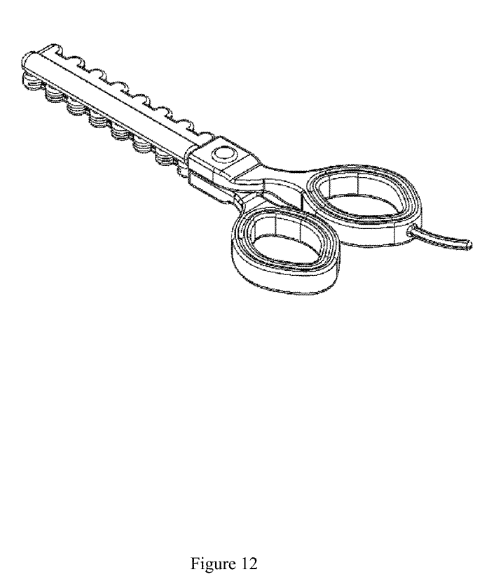

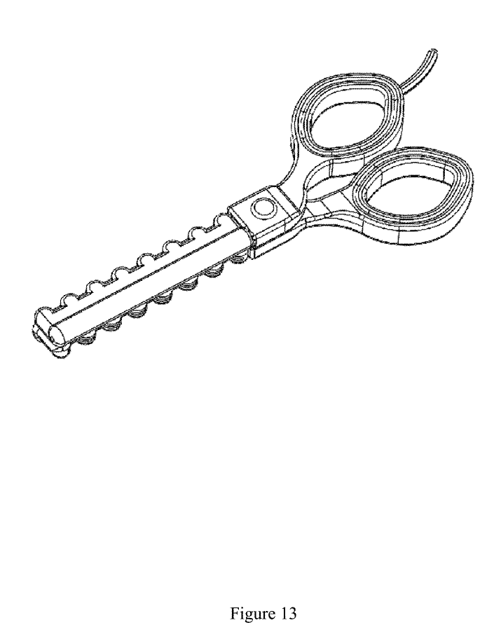

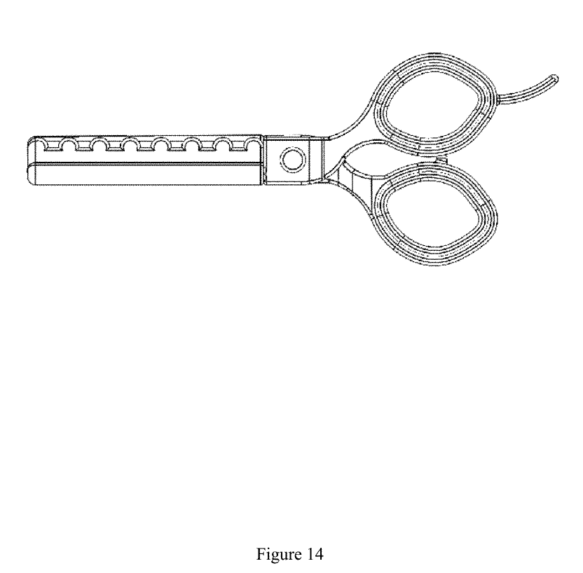

Referring to the figures, FIG. 1-14 shows the scissors device of the present invention. The figures show the various features of the device including removable and disposable razor blades on the scissors cutting surface. These blades allow a user to easily remove a dull blade and replace it with a new blade. The device includes a comfortable gripping surface on the interior handles and is available in multiple colors. The interior cutting surfaces include the ability to add a guard, the guard protecting the blade from the user of the device.

Various related embodiments of the invention are also described in Appendix A, which is incorporated herein by reference in its entirety.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A scissors, as herein shown and described.

2. A scissors, the scissors having a cutting surface comprised of a razor blade, the razor blade removable and disposable, as herein shown and described.
